(19) United States
(12) Patent Application Publication
(10) Pub. No.: US 2019/0363369 A1
(43) Pub. Date: Nov. 28, 2019

(54) FILAMENT BATTERY

(71) Applicant: Murata Manufacturing Co., Ltd., Nagaokakyo-shi (JP)

(72) Inventors: Masahiko Kondo, Nagaokakyo-shi (JP); Makoto Yoshioka, Nagaokakyo-shi (JP)

(21) Appl. No.: 16/535,343

(22) Filed: Aug. 8, 2019

Related U.S. Application Data
(63) Continuation of application No. PCT/JP2017/044556, filed on Dec. 12, 2017.

(30) Foreign Application Priority Data
Feb. 23, 2017 (JP) 2017-031846

(51) Int. Cl. H01M 4/75; H01M 2/26

(52) U.S. Cl. CPC H01M 4/75; H01M 10/0562; H01M 2/263

(57) ABSTRACT

A filament battery that includes a tubular member having flexibility, a plurality of all-solid storage elements, and a flexible connection member. The plurality of all-solid storage elements are disposed in the tubular member at intervals along an extending direction of the tubular member. The flexible connection member electrically connects the plurality of all-solid storage elements to each other.

### CROSS REFERENCE TO RELATED APPLICATIONS

The present application is a continuation of International application No. PCT/JP2017/044556, filed Dec. 12, 2017, which claims priority to Japanese Patent Application No. 2017-031846, filed Feb. 23, 2017, the entire contents of each of which are incorporated herein by reference.

### FIELD OF THE INVENTION

The present invention relates to a filament battery.

### BACKGROUND OF THE INVENTION

Patent Document 1 describes a linear-shaped battery in which a solid electrolyte layer is formed on the outer periphery of a linear negative electrode or positive electrode, the other electrode is formed on the outer side of the solid electrolyte layer, and a covering layer is formed on the outer side of the other electrode.

Patent Document 1 describes that the linear-shaped battery described therein has flexibility to such an extent that the battery can be disposed along a dead space in an electronic device.

Patent Document 1: Japanese Patent Application Laid-Open No. H4-169066

### SUMMARY OF THE INVENTION

There is a demand to improve the flexibility of the linear battery (hereinafter, referred to as “filament battery”) described in Patent Document 1. Filament batteries also include linear-shaped batteries such as cable-shaped, string-shaped, rope-shaped, and hawser-shaped batteries.

The main object of the present invention is to provide a filament battery with high flexibility.

The filament battery according to the present invention includes a tubular member, a plurality of all-solid storage elements, and a flexible connection member. The tubular member has flexibility. The plurality of all-solid storage elements are disposed in the tubular member at intervals along an extending direction of the tubular member. The flexible connection member electrically connects the plurality of all-solid storage elements to each other.

In the filament battery according to the present invention, the portion of the tubular member in which no all-solid storage elements are disposed has flexibility. Therefore, the filament battery according to the present invention has high flexibility.

In the filament battery according to the present invention, the flexible connection member may have a sheet shape.

In the filament battery according to the present invention, the flexible connection member may have a string shape.

In the filament battery according to the present invention, it is preferable that at least one of the ridge line portion or the corner portion of the all-solid storage element has a chamfered or rounded shape.

In the filament battery according to the present invention, it is preferable that the all-solid storage element has a rectangular parallelepiped shape with a longest side of 1 mm or less.

In the filament battery according to the present invention, it is preferable that the inside of the tubular member is filled with a resin.

In the filament battery according to the present invention, the all-solid storage elements each preferably have a solid electrolyte layer, a first electrode on a first main surface of the solid electrolyte layer, and a second electrode on a second main surface of the solid electrolyte layer, and the flexible connection member includes a first flexible connection member electrically connecting the first electrodes of the plurality of all-solid storage elements, and a second flexible connection member electrically connecting the second electrodes of the plurality of all-solid storage elements.

According to the present invention, it is possible to provide a filament battery with high flexibility.

### BRIEF EXPLANATION OF THE DRAWINGS

FIG. 1 is a schematic perspective view of a filament battery according to a first embodiment.

FIG. 2 is a schematic cross-sectional view of the filament battery taken along a line II-II in FIG. 1.

FIG. 3 is a schematic plan view of all-solid storage elements and a flexible connection member as viewed along an arrow III in FIG. 2.

FIG. 4 is a schematic perspective view of an all-solid storage element in the first embodiment.

FIG. 5 is a schematic cross-sectional view of the all-solid storage element taken along a line V-V of FIG. 4.

FIG. 6 is a schematic plan view of all-solid storage elements and a flexible connection member in a second embodiment.

FIG. 7 is a schematic cross-sectional view of a filament battery according to a third embodiment.

FIG. 8 is a schematic cross-sectional view of a filament battery according to a fourth embodiment.

### DETAILED DESCRIPTION OF THE INVENTION

Hereinafter, an example of preferred embodiments of the present invention will be described. However, the following embodiments are merely examples. The present invention is not limited to the following embodiments at all.

Further, members having substantially the same functions are referred to by the same reference numerals in the drawings referred to in the embodiments and the like. The drawings referred to in the embodiments and the like are schematically described. The dimensional ratios of objects drawn in the drawings may differ from the dimensional ratios of real objects. The dimensional ratios of objects and the like may differ for different figures. The specific dimensional ratios of objects and the like should be determined in consideration of the following description.

### First Embodiment

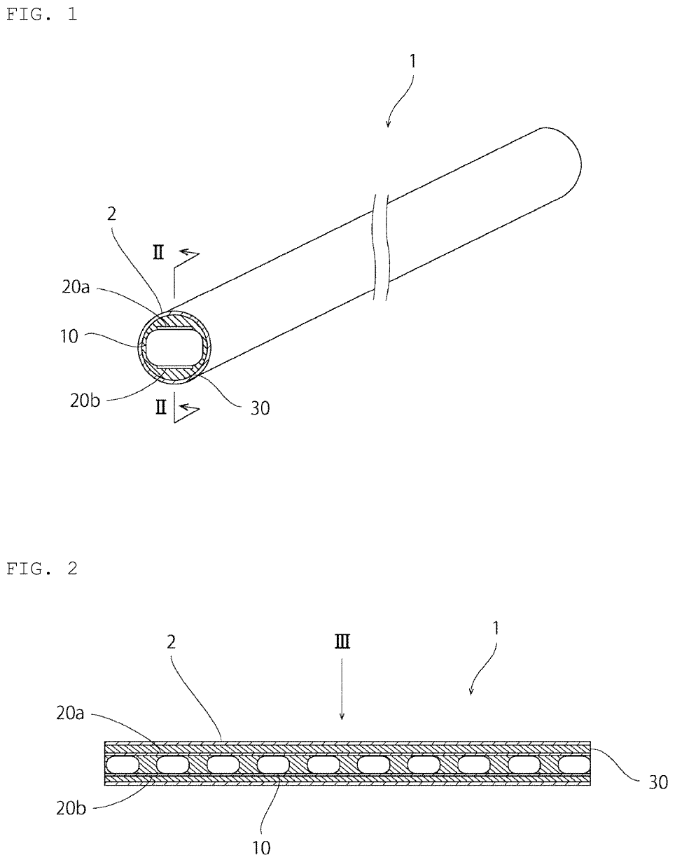

FIG. 1 is a schematic perspective view of a filament battery according to a first embodiment. FIG. 2 is a schematic cross-sectional view of the filament battery taken along a line II-II in FIG. 1.

A filament battery 1 includes a tubular member 2, a plurality of all-solid storage elements 10, and flexible connection members 20a and 20b.

The tubular member 2 is not particularly limited as long as it has flexibility. The tubular member 2 can be made of, for example, metal, elastomer, rubber, paper or resin. Further, it is also possible to use materials in which these materials are combined, and materials in which these materials and inorganic materials are combined. Particularly, as described later, the tubular member 2 is preferably made of a waterproof laminate material in which a metal layer is sandwiched between resin layers, from the viewpoint of protecting the all-solid storage elements 10 and the flexible connection members 20a and 20b disposed in the tubular member 2 from moisture. Further, the tubular member 2 is preferably made of a heat-shrinkable resin having insulation properties, a hot-melt resin or the like, from the viewpoint of preventing a short circuit from occurring even when the flexible connection members 20a and 20b and the all-solid storage elements 10 are in contact with the tubular member 2.

Further, the cross-sectional shape of the tubular member 2 is not particularly limited, and, for example, it may be circular, oval, elliptical, rectangular, polygonal, rectangular having rounded corner portions or the like.

As illustrated in FIG. 2, the plurality of all-solid storage elements 10 are disposed in the tubular member 2. Specifically, the plurality of all-solid storage elements 10 are disposed at intervals along the extending direction of the tubular member 2.

In this embodiment, an example in which the plurality of all-solid storage elements 10 having the same shape and the same size is disposed will be described. However, the present invention is not limited to this configuration. In the present invention, the plurality of all-solid storage elements disposed in the tubular member 2 may include all-solid storage elements having a shape different from the other all-solid storage elements or all-solid storage elements having different sizes. Further, for example, the plurality of all-solid storage elements may have different shapes or different sizes.

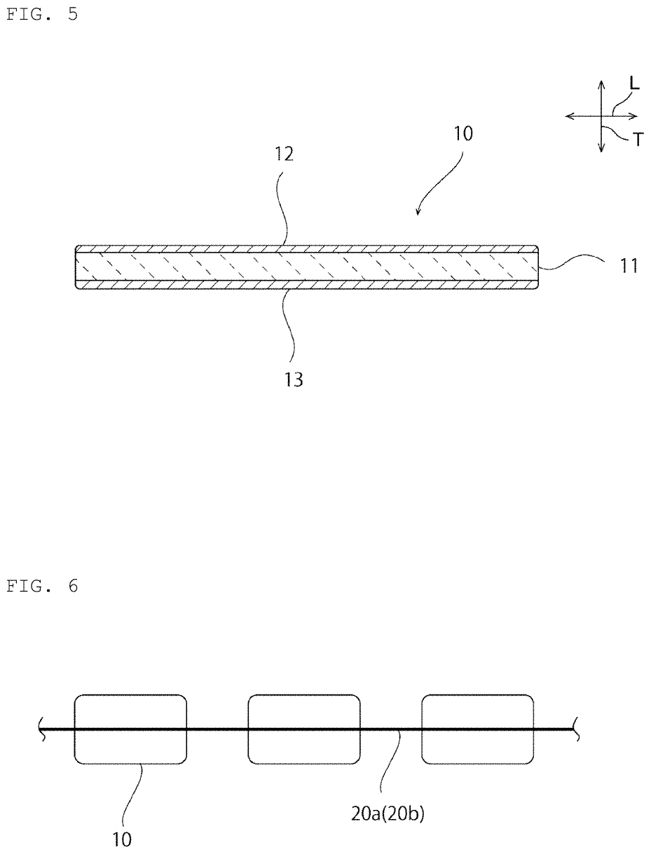

The all-solid storage element 10 disposed in the tubular member 2 has a rectangular parallelepiped shape as illustrated in FIGS. 4 and 5. Specifically, in this embodiment, the all-solid storage element 10 has a rectangular parallelepiped shape whose dimension in a length direction L is longer than the dimension in a width direction W. The dimension in the length direction L of the all-solid storage element 10 is preferably from 1.1 times to 5 times the dimension in the width direction W, and more preferably from 1.5 times to 3 times. Specifically, in this embodiment, the dimension in the length direction L of the all-solid storage element 10 is twice the dimension in the width direction W.

In the present invention, the “rectangular parallelepiped shape” includes a rectangular parallelepiped shape in which at least one of a ridge line portion and a corner portion has a chamfered shape or a rounded shape and a rectangular parallelepiped shape in which at least one of a ridge line portion and a corner portion has a chamfered or rounded shape.

In this embodiment, specifically, the ridge line portion and the corner portion of the all-solid storage element 10 have a rounded shape.

The dimensions of the all-solid storage element 10 are not particularly limited, and the length of the longest side is preferably 30 mm or less, preferably 3.2 mm or less, and more preferably 1 mm or less. With such a dimension, it is possible to suppress breakage of the all-solid storage element 10.

The all-solid storage element 10 is not particularly limited as long as it is a storage element in which all the constituent elements are solid.

As illustrated in FIG. 5, in this embodiment, the all-solid storage element 10 includes an all-solid electrolyte layer 11 formed of an all-solid electrolyte layer, a first electrode 12, and a second electrode 13. The first electrode 12 is disposed on one main surface (first main surface) of the all-solid electrolyte layer 11, while the second electrode 13 is disposed on the other main surface (second main surface) of the all-solid electrolyte layer 11. In other words, the all-solid electrolyte layer 11 is sandwiched between the first electrode 12 and the second electrode 13 opposed to each other.

One of the first and second electrodes 12 and 13 constitutes a positive electrode, and the other constitutes a negative electrode. In this embodiment, an example in which the first electrode 12 constitutes a negative electrode and the second electrode 13 constitutes a positive electrode will be described hereinbelow.

The first electrode 12 has a negative electrode current collector and a negative electrode active material layer. The negative electrode current collector is not particularly limited as long as it has electron conductivity. The negative electrode current collector can be made of, for example, carbon, an oxide or composite oxide having high electron conductivity or a metal. The negative electrode current collector can be made of, for example, Pt, Au, Ag, Al, Cu, stainless steel or ITO (indium tin oxide).

The negative electrode active material layer is provided on the negative electrode current collector. In this embodiment, the negative electrode active material layer is made of a sintered body including negative electrode active material particles, solid electrolyte particles, and conductive particles. Specific examples of the negative electrode active material to be preferably used include a compound represented by the formula MOₓ (M is at least one selected from the group consisting of Ti, Si, Sn, Cr, Fe, Nb, V, and Mo. X is 0.9 or more and 3.0 or less), a graphite-lithium compound, a lithium alloy, a lithium-containing phosphate compound having a NaSICON-type structure, a lithium-containing phosphate compound having an olivine-type structure, and a lithium-containing oxide having a spinel-type structure. In the compound represented by MOₓ, part of oxygen may be substituted by P or Si, or Li may be contained. In other words, a compound represented by Li_{Y}MO_{X} (M is at least one selected from the group consisting of Ti, Si, Sn, Cr, Fe, Nb, V, and Mo. 0.9≤X≤3.0, 2.0≤Y≤4.0) can also be suitably used. Specific examples of lithium alloys to be preferably used include Li—Al. Specific examples of the lithium-containing phosphate compound having a NaSICON-type structure which is preferably used include Li₃V₂(PO₄)₃. Specific examples of the lithium-containing phosphate compound having an olivine-type structure to be preferably used include Li₃FePO₄. Specific examples of the lithium-containing oxide having a spinel-type structure to be preferably used include Li₄Cu₅O₁₂. Only one kind of these negative electrode active materials may be used, or a plurality of kinds thereof may be mixed and used.

Specific examples of the solid electrolyte to be preferably used include a lithium-containing phosphate compound having a NaSICON structure, an oxide solid electrolyte having a perovskite structure, and an oxide solid electrolyte having a garnet-type or garnet-like structure. Examples of the lithium-containing phosphate compound having a NaSICON structure which is preferably used include LiₓM_{y}(PO₄)₃ (0.9≤x≤1.9, 1.9≤y≤2.1, M is at least one selected from the group consisting of Ti, Ge, Al, Ga, and Zr). Specific examples of the lithium-containing phosphate compound having a NaSICON structure which is preferably used include Li_{1.2}Al_{0.2}Ti_{1.8}(PO₄)₃. Specific examples of the oxide solid electrolyte having a perovskite structure which is preferably used include La_{0.55}Li_{0.35}TiO₃. Specific examples of the oxide solid electrolyte having a garnet-type or garnet-like structure which is preferably used include Li_{1.4}Al_{0.4}Ge_{1.6}(PO₄)₃ and Li₇La₃Zr₂O₁₂. Only one kind of these solid electrolytes may be used, or a plurality of kinds thereof may be mixed and used.

Preferably used conductive particles contained in the negative electrode active material layer can be made of, for example, a metal such as Ag, Au, Pt or Pd, carbon, a compound having electron conductivity or a combination thereof. Further, these substances having conductivity may be contained in a state in which surfaces of positive electrode active material particles or the like are covered with the substances.

Note that the negative electrode current collector does not necessarily need to be provided in the first electrode. For example, the first electrode may be made of a negative electrode active material layer. For example, the first electrode may be made of metallic lithium.

The second electrode 13 is opposed to the first electrode 12 with the all-solid electrolyte layer 11 interposed therebetween. The second electrode 13 has a positive electrode current collector and a positive electrode active material layer. The positive electrode active material layer is provided on the positive electrode current collector. The second electrode 13 is disposed such that the positive electrode active material layer is opposed to the negative electrode active material layer. The positive electrode current collector is not particularly limited as long as it has electron conductivity. The positive electrode current collector can be made of, for example, carbon, an oxide or composite oxide having high electron conductivity or a metal. The positive electrode current collector can be made of, for example, Pt, Au, Ag, Al, Cu, stainless steel or ITO (indium tin oxide).

The positive electrode active material layer is made of a sintered body including positive electrode active material particles, solid electrolyte particles, and conductive particles. Examples of the positive electrode active material to be preferably used include a lithium-containing phosphate compound having a NaSICON-type structure, a lithium-containing phosphate compound having an olivine-type structure, a lithium-containing layered oxide, and a lithium-containing oxide having a spinel-type structure. Specific examples of the lithium-containing phosphate compound having a NaSICON-type structure which is preferably used include Li₃V₂(PO₄)₃. Specific examples of the lithium-containing phosphate compound having an olivine-type structure to be preferably used include Li₃FePO₄, LiCoPO₄, and LiMnPO₄. Specific examples of the lithium-containing layered oxide to be preferably used include LiCoO₂ and LiCo_{1/3}Ni_{1/3}Mn_{1/3}O₂. Specific examples of the lithium-containing oxide having a spinel-type structure to be preferably used include LiMn₂O₄ and LiNi_{0.5}Mn_{1.5}O₄. Only one kind of these positive electrode active materials may be used, or a plurality of kinds thereof may be mixed and used.

Examples of materials preferably used as the solid electrolyte contained in the positive electrode active material layer include materials preferably used as the solid electrolyte which are similar to the materials preferably used as the solid electrolyte contained in the negative electrode active material layer.

Specific examples of the conductive particles contained in the positive electrode active material layer include particles which are similar to the particles preferably used as the conductive particles contained in the negative electrode active material layer.

Note that the positive electrode current collector does not necessarily need to be provided in the second electrode. For example, the second electrode may be made of a positive electrode active material layer.

The all-solid electrolyte layer 11 is disposed between the first electrode 12 and the second electrode 13. In this embodiment, each of the first electrode 12 and the second electrode 13 is directly bonded to the all-solid electrolyte layer 11. In detail, the first electrode 12, the all-solid electrolyte layer 11, and the second electrode 13 are integrally sintered. In other words, the all-solid storage element 10 is an integral sintered body of the first electrode 12, the all-solid electrolyte layer 11, and the second electrode 13.

The all-solid electrolyte layer 11 is made of a sintered body of solid electrolyte particles. Specific examples of the solid electrolyte to be preferably used include a lithium-containing phosphate compound having a NaSICON structure, an oxide solid electrolyte having a perovskite structure, and an oxide solid electrolyte having a garnet-type or garnet-like structure. Examples of the lithium-containing phosphate compound having a NaSICON structure which is preferably used include LiₓM_{y}(PO₄)₃ (0.9≤x≤1.9, 1, 9≤y≤2.1, M is at least one selected from the group consisting of Ti, Ge, Al, Ga, and Zr). Specific examples of the lithium-containing phosphate compound having a NaSICON structure which is preferably used include Li_{1.4}Al_{0.4}Ge_{1.6}(PO₄)₃ and Li_{1.2}Al_{0.2}Ti_{1.8}(PO₄)₃. Specific examples of the oxide solid electrolyte having a perovskite structure which is preferably used include La_{0.55}Li_{0.35}TiO₃. Specific examples of the oxide solid electrolyte having a garnet-type or garnet-like structure which is preferably used include Li₇La₃Zr₂O₁₂. Only one kind of these solid electrolytes may be used, or a plurality of kinds thereof may be mixed and used.

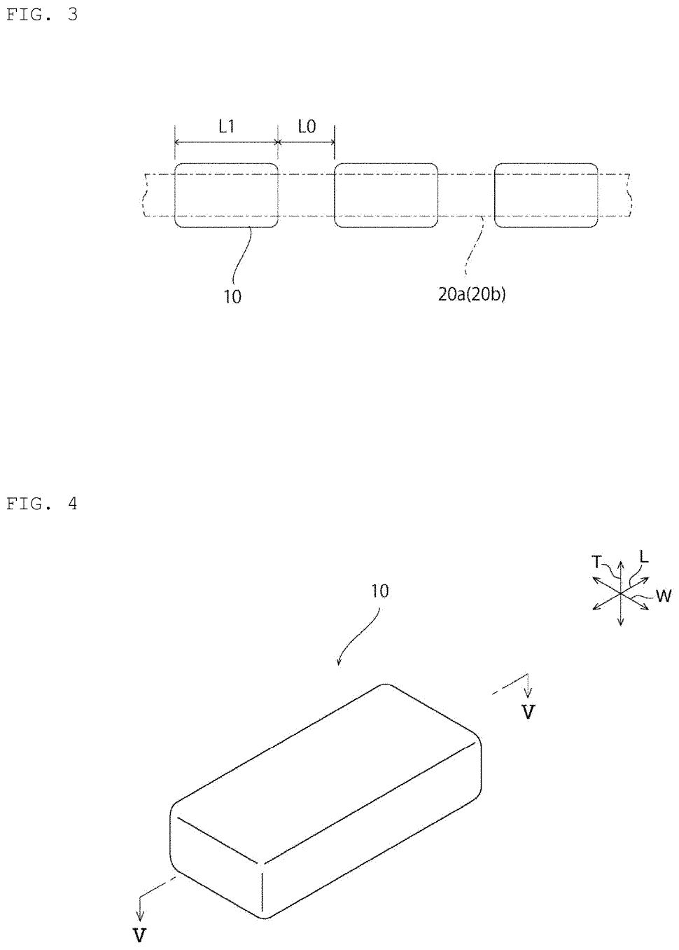

As illustrated in FIG. 3, the plurality of all-solid storage elements 10 are electrically connected by the first flexible connection member 20a and the second flexible connection member 20b. Specifically, the plurality of all-solid storage elements 10 are connected in parallel by the first flexible connection member 20a and the second flexible connection member 20b.

The first flexible connection member 20a and the second flexible connection member 20b are not particularly limited as long as they electrically connect the all-solid storage elements 10 adjacent to each other. The first flexible connection members 20a and the second flexible connection member 20b may have, for example, a sheet shape or a string shape. In this embodiment, an example in which the first flexible connection member 20a and the second flexible connection member 20b have a sheet shape will be described.

The sheet-shaped first and second flexible connection members 20a and 20b may be made of, for example, a sheet of conductive film (e.g., a metal film), or may be made of a laminated body of an insulating film of a resin or the like and a conductive film on the insulating film.

The plurality of all-solid storage elements 10 is arranged between the first flexible connection member 20a and the second flexible connection member 20b, at intervals along the extending direction of the tubular member 2. Specifically, the plurality of all-solid storage elements 10 is disposed such that the first electrode 12 faces one side and the second electrode 13 faces the other side. The first electrodes 12 of the plurality of all-solid storage elements 10 are electrically connected by the first flexible connection member 20a. The second electrodes 13 of the plurality of all-solid storage elements 10 are electrically connected by the second flexible connection member 20b.

However, in the present invention, the first electrodes of the plurality of all-solid storage elements do not necessarily need to be connected by one first flexible connection member. For example, a plurality of first flexible connection members may be provided to connect the first electrodes of the adjacent all-solid storage elements. Similarly, the second electrodes of the plurality of all-solid storage elements do not necessarily need to be connected by one second flexible connection member. For example, a plurality of second flexible connection members may be provided to connect the second electrodes of the adjacent all-solid storage elements.

The inside of the tubular member 2 is filled with a resin 30. The resin 30 is filled in the tubular member 2, so that it is possible to prevent the all-solid storage elements 10 disposed in the tubular member 2 from colliding with each other, or it is possible to prevent the first electrode 12 and the second electrode 13 from short-circuiting. Further, it is possible to suppress peeling of the flexible connection members 20a and 20b from the electrodes 12 and 13.

The resin 30 filled in the tubular member 2 is not particularly limited as long as it is of a type that has flexibility and insulation properties. Instead of the resin 30, it is possible to use an insulator including, for example, paper, an elastomer or an inorganic substance.

In the present invention, the inside of the tubular member does not necessarily need to be filled with the resin. In the present invention, an air gap may be provided inside the tubular member.

As described above, in the filament battery 1, the plurality of all-solid storage elements 10 is disposed in the tubular member 2 having flexibility at intervals, and the plurality of all-solid storage elements 10 is connected by the flexible connection members 20a and 20b. For this reason, in the filament battery 1, a portion in which the all-solid storage element 10 is not provided has flexibility. Therefore, the filament battery 1 has high flexibility.

From the viewpoint of obtaining the filament battery 1 having higher flexibility, when the length of the all-solid storage element 10 along the extending direction of the tubular member 2 is L1 and the interval between the adjacent all-solid storage elements 10 is L0, L0/L1 is preferably 0.1 or more, and more preferably 0.5 or more. However, if L0/L1 is too large, the area ratio of the all-solid storage elements 10 to the unit length of the filament battery 1 is too small, whereby the energy density per unit length of the filament battery 1 may be too low. Therefore, L0/L1 is preferably 3 or less, more preferably 2 or less, and still more preferably 1 or less.

When S1 is a cross-sectional area of the filament battery 1 and S0 is a cross-sectional area of the all-solid storage element 10, S0/S1 is preferably 0.9 or less, more preferably 0.5 or less, and still more preferably 0.3 or less, from the viewpoint similar to the above. However, if S0/S1 is too small, the area ratio of the all-solid storage element 10 per unit area is too small, whereby the energy density per unit area may be too low. Therefore, S0/S1 is preferably 0.2 or more, and more preferably 0.3 or more.

In this embodiment, the ridge line portion and the corner portion of the all-solid storage element 10 have a rounded shape. With such a shape, the filament battery 1 can be more easily bent.

In the filament battery 1, the capacity of the filament battery 1 can be freely changed by changing the number of all-solid storage elements 10 connected in parallel or changing the capacity of the all-solid storage elements 10.

Hereinafter, other examples of preferred embodiments of the present invention will be described. In the following description, members having substantially the same functions as those of the first embodiment are referred to by the same reference numerals, and the description thereof is omitted.

### Second Embodiment

FIG. 6 is a schematic plan view of all-solid storage elements and a flexible connection member in a second embodiment.

In the first embodiment, an example in which the first and second flexible connection members 20a and 20b have a sheet shape has been described. However, the present invention is not limited to this configuration.

In the filament battery according to the second embodiment, the first and second flexible connection members 20a and 20b have a string shape.

For example, in the case where the flexible connection members 20a and 20b have a sheet shape, it is possible to increase a contact area between the flexible connection member 20a and the electrode 12 of the all-solid storage element 10 and a contact area between the flexible connection member 20b and the electrode 13 of the all-solid storage element 10, as a result of which it is possible to lower the resistance in the battery. Further, in the case of the sheet-shaped flexible connection members 20a and 20b, it is easy to attach an electrode plate made of metal or the like at the terminal ends of the members or between the all-solid storage elements 10. For example, this electrode plate can be used as an external extended terminal. However, although in the case of using the sheet-shaped flexible connection members 20a and 20b, high flexibility is obtained in the thickness direction of the flexible connection members 20a and 20b, high flexibility is unlikely to be obtained in the width direction of the flexible connection members 20a and 20b. On the other hand, in the case of using the string-shaped flexible connection members 20a and 20b, high flexibility can be realized in any direction in the radial direction of the filament battery. However, in the case of using the string-shaped flexible connection members 20a and 20b, the contact area between the string-shaped flexible connection member 20a and the electrode 12 of the all-solid storage element 10 and the contact area between the string-shaped flexible connection member 20b and the electrode 13 of the all-solid storage element 10 are small, as a result of which the resistance in the battery is likely to be high. Therefore, the string-shaped flexible connection members 20a and 20b are preferably made of a material having low electrical resistance such as metal. Further, it is also possible to use a plurality of string-shaped flexible connection members 20a and a plurality of string-shaped flexible connection members 20b. The risk of disconnection can be reduced by using the plurality of string-shaped flexible connection members 20a and the plurality of string-shaped flexible connection members 20b. Furthermore, a plurality of loads can be utilized by individually connecting the plurality of string-shaped flexible connection members 20a and the plurality of string-shaped flexible connection members 20b to different loads.

### Third and Fourth Embodiments

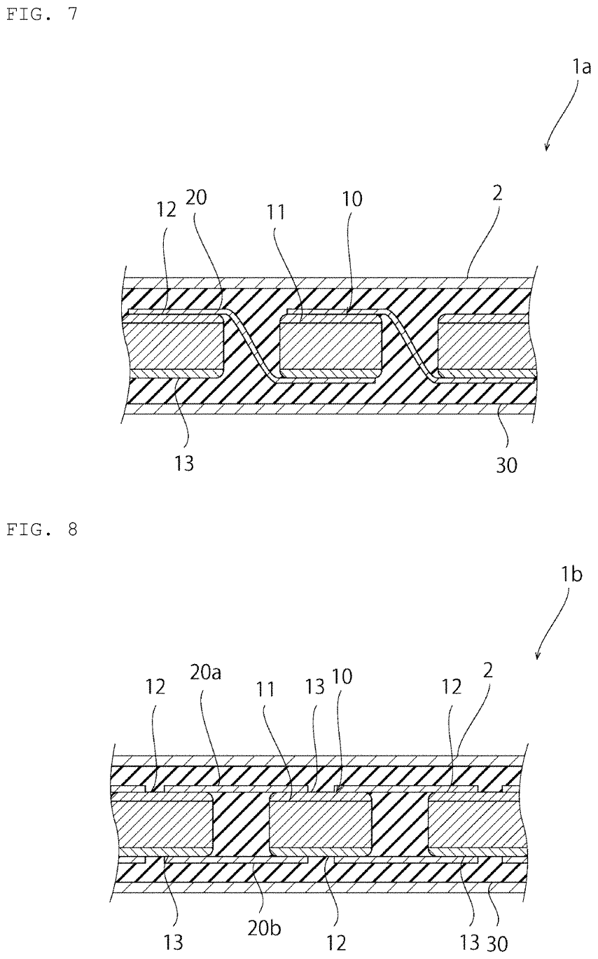

FIG. 7 is a schematic cross-sectional view of a filament battery according to a third embodiment. FIG. 8 is a schematic cross-sectional view of a filament battery according to a fourth embodiment.

In the first and second embodiments, the example in which the plurality of all-solid storage elements 10 is connected in parallel has been described. However, in the present invention, the plurality of all-solid storage elements 10 does not necessarily need to be connected in parallel.

For example, as in the case of a filament battery 1a illustrated in FIG. 7, the plurality of all-solid storage elements 10 may be connected in series by connecting the first electrode 12 and the second electrode 13 of the adjacent all-solid storage elements 10 using the flexible connection member 20.

For example, as in a filament battery 1b illustrated in FIG. 8, the plurality of all-solid storage elements 10 may be connected in series by connecting the first electrode 12 and the second electrode 13 of the adjacent all-solid storage elements 10 using the first flexible connection member 20a, and connecting the first electrode 12 and the second electrode 13 of the adjacent all-solid storage elements 10 using the second flexible connection member 20b.

In the case where the plurality of all-solid storage elements 10 is connected in parallel, it is possible to realize a filament battery having a large capacity. In the case where the plurality of all-solid storage elements 10 is connected in series, it is possible to realize a filament battery having a high voltage.

### DESCRIPTION OF REFERENCE SYMBOLS

1, 1a, 1b: Filament battery
2: Tubular member
10: All-solid storage element
11: All-solid electrolyte layer
12: First electrode
13: Second electrode
20: Flexible connection member
20a: First flexible connection member
20b: Second flexible connection member

1. A filament battery comprising:
a tubular member having flexibility and defining an internal space;
a plurality of all-solid storage elements within the internal space of the tubular member and disposed at intervals along an extending direction of the tubular member; and
a flexible connection member electrically connecting the plurality of all-solid storage elements to each other.

2. The filament battery according to claim 1, wherein the plurality of all-solid storage elements have a same shape and a same size.

3. The filament battery according to claim 1, wherein the flexible connection member is a first flexible connection member, and the filament battery further comprises a second flexible connection member connecting the plurality of all-solid storage elements to each, wherein the plurality of all-solid storage elements are connected in parallel by the first flexible connection member and the second flexible connection member.

4. The filament battery according to claim 1, wherein the flexible connection member connects adjacent all-solid storage elements of the plurality of all-solid storage elements to each other in series.

5. The filament battery according to claim 1, wherein the flexible connection member has a sheet shape.

6. The filament battery according to claim 1, wherein the flexible connection member has a string shape.

7. The filament battery according to claim 1, wherein at least one of a ridge line portion or a corner portion of each of the all-solid storage elements has a chamfered or rounded shape.

8. The filament battery according to claim 1, wherein each of the all-solid storage elements has a rectangular parallelepiped shape with a longest side thereof of 1 mm or less.

9. The filament battery according to claim 1, further comprising a resin filling the internal space of the tubular member.

10. The filament battery according to claim 1, wherein the resin is of a type that has flexibility and insulation properties.

11. The filament battery according to claim 1, wherein the plurality of all-solid storage elements each have a solid electrolyte layer, a first electrode on a first main surface of the solid electrolyte layer, and a second electrode on a second main surface of the solid electrolyte layer, and
the flexible connection member is a first flexible connection member electrically connecting the first electrodes of the plurality of all-solid storage elements to each other, and the filament battery further comprises a second flexible connection member electrically connecting the second electrodes of the plurality of all-solid storage elements to each other.

12. The filament battery according to claim 11, wherein all-solid electrolyte layer is made of a sintered body of solid electrolyte particles.

13. The filament battery according to claim 12, wherein the solid electrolyte particles are selected from one or more of a lithium-containing phosphate compound having a NaSICON structure, an oxide solid electrolyte having a perovskite structure, and an oxide solid electrolyte having a garnet-type structure.

14. The filament battery according to claim 1, wherein, when a length of an all-solid storage element of the plurality of all-solid storage elements along the extending direction of the tubular member is L1 and an interval between adjacent all-solid storage elements of the plurality of all-solid storage elements is L0, L0/L1 is 0.1 to 3.

15. The filament battery according to claim 14, wherein L0/L1 is 0.5 to 2.

16. The filament battery according to claim 1, wherein, when S1 is a cross-sectional area of the filament battery and S0 is a cross-sectional area of an all-solid storage element of the plurality of all-solid storage elements, S0/S1 is 0.2 to 0.9.

17. The filament battery according to claim 16, wherein S0/S1 is 0.3 to 0.5.
